(19) United States
(12) Patent Application Publication
(10) Pub. No.: US 2023/0176681 A1
(43) Pub. Date: Jun. 8, 2023

(54) HOVERING TOUCH PANEL AND HOVERING TOUCH DEVICE

(71) Applicant: eGalax_eMPIA Technology Inc., Taipei (TW)

(72) Inventor: Cheng-Han LEE, Taipei (TW)

(21) Appl. No.: 17/666,691

(22) Filed: Feb. 8, 2022

(30) Foreign Application Priority Data
Dec. 3, 2021 (TW) 110145305

(51) Int. Cl. G06F 3/041; G06F 3/044

(52) U.S. Cl. CPC G06F 3/04164; G06F 3/0445; G06F 3/0446; G06F 2203/04108

(57) ABSTRACT

The invention provides a hovering touch panel/hovering touch device, which includes a plurality of driving lines extending along a first axis, a plurality of sensing lines extending along a second axis and intersecting the driving lines respectively, the intersections of the driving lines and the sensing lines each forming a respective intersected point, and a plurality of hovering units respectively set on the driving lines or the sensing lines between adjacent intersected points, each hovering unit having an even number of linear hovering sections connected to the same point of each driving line or sensing line.

This application claims the priority benefit of Taiwan patent application number 110145305, filed on Dec. 3, 2021.

### BACKGROUND OF THE INVENTION

### 1. Field of the Invention

The present invention relates a hovering touch technology and more particularly to a hovering touch panel, which is provided with a plurality of hovering units, and uses the tips of the hovering sections to increase the strength of the surrounding electric field, so as to achieve the detection of objects farther from the hovering touch panel during hovering detection, which can apply mutual capacitance technology to achieve multi-point detection of hovering objects and overcome the problem that self-capacitance hovering detection can only perform single-point detection, and must switch to mutual capacitance detection when touching the touch panel.

### 2. Description of the Related Art

The conventional touch panel is equipped with a sensing area on a substrate, and the sensing area is used to sense the signal of a human finger or a stylus to form a touch function. Most of the materials used in the sensing area use transparent electrodes (for example: indium tin oxide ITO). During operation, the user can touch and press the corresponding picture on the screen of the touch panel to achieve the function of touch input operation.

At present, touch technology can be divided into different types such as resistive type, capacitive induction type, infrared induction type, electromagnetic induction type, sonic induction type, etc. Among them, capacitive-sensitive touch panels are the most widely used. Its working principle is to use the capacitance formed between the plural transparent electrodes and the human body to cause the capacitance change of the transparent electrode itself to obtain the coordinates of the touch position. The capacitive sensing touch panel has many advantages, so it has been widely adopted.

In addition, hovering touch is a technology that is getting more and more attention from users nowadays. Because the user does not need to touch the surface of the touch panel, it has been applied to smartphones, tablets, notebook computers, as well as car input devices and other electronic products with screens. This technology allows users to operate without touching the screen with their fingers, keeping a certain distance from the screen. Hovering touch includes a variety of technologies, such as optical, electromagnetic, and capacitive. Since capacitive hovering touch is based on a general projected capacitive touch panel, it has an advantage in cost compared to other technologies. When the finger approaches but has not touched the touch panel, hover detection starts, and when the finger actually touches the touch panel, it switches to contact touch detection.

However, in order to obtain a better signal, the common capacitive hovering touch uses self-capacitance technology for hover detection. However, due to technical limitations of self-capacitance, it is difficult to perform multi-finger detection, and can only accurately detect the position of one finger.

### SUMMARY OF THE INVENTION

Therefore, in view of the above-mentioned problems, the inventor collected relevant information, and after multiple evaluations and considerations, he designed such a hovering touch device.

It is therefore a main object of the present invention to provide a hovering touch panel, which comprises a plurality of driving lines, a plurality of sensing lines, and a plurality of hovering units. The driving lines extend along a first axis. The sensing lines extend along a second axis and intersect the driving lines respectively. The intersections of the driving lines and the sensing lines each form a respective intersected point. The hovering units are respectively set on the driving lines or the sensing lines between adjacent intersected points. Each hovering unit comprises an even number of linear hovering sections connected to the same point of each driving line or sensing line.

Preferably, the position where each hovering section is connected to each driving line or sensing; line is roughly located at the center point between any two intersected points.

Preferably, the angle between any two adjacent hovering sections is equal.

Preferably, each hovering section presents a central radial. arrangement, and the arrangement is symmetrically arranged on the left and right sides and the top and bottom sides.

Preferably, the distance between the tips of each two adjacent hovering sections of each hovering unit is between ⅕ and ⅘ of the distance between each two adjacent intersected points.

Preferably, the driving lines and the sensing lines are all straight lines, and the line width of the driving lines and the sensing lines is less than 2 mm.

Preferably, the hovering units, the driving lines, and the sensing lines are made of transparent conductive materials.

### BRIEF DESCRIPTION OF THE DRAWINGS

FIG. 1 is a schematic diagram of the hovering touch device of the present invention.

FIG. 2 is a diagram of the layered structure of the hovering touch panel of the present invention.

FIG. 3 is an embodiment diagram of the hovering units of the present invention arranged on the sensing lines.

FIG. 4 is a structural diagram of the hovering unit of the present invention.

FIG. 5 is a first schematic diagram of the hovering unit sensing an object of the present invention.

FIG. 6 is a second schematic diagram of the hovering unit sensing an object of the present invention.

FIG. 7 is a scale diagram of the driving lines, sensing lines and intersected points of the present invention.

FIG. 8 is an embodiment diagram of the hovering units of the present invention arranged on the driving lines.

FIG. 9 is a schematic diagram of the hovering touch panel sensing an object of the present invention.

FIG. 10 is an embodiment diagram of the hovering units of the present invention arranged on the driving lines and the sensing lines.

FIG. 11 is another schematic diagram of the hovering touch panel sensing an object of the present invention.

### DETAILED DESCRIPTION OF THE PREFERRED EMBODIMENT

In order to achieve the above-mentioned objects and effect, the technical means adopted by the present invention and its structure, the preferred embodiment of the present invention is illustrated in detail as follows, and its features and functions are as follows, for the benefit of a complete understanding.

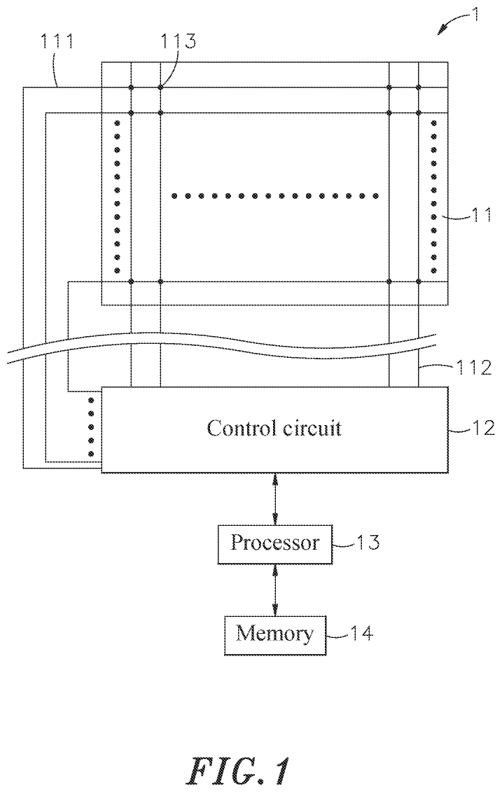

As shown in FIG. 1, a hovering touch device 1 of the present preferred embodiment comprises a hovering touch panel 11, a control circuit 12, a processor 13 and a memory 14, and its main structure and features are detailed as follows:

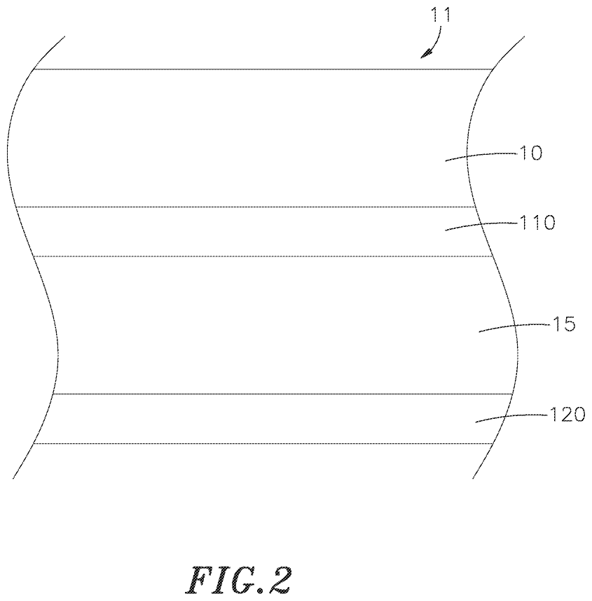

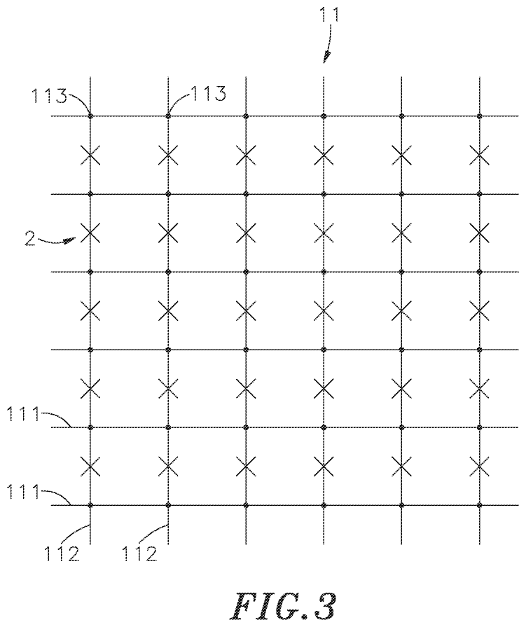

As shown in FIGS. 2 and 3, the hovering touch panel 11 comprises a transparent cover plate 10, and a driving electrode layer 110 is provided under the transparent cover plate 10. The driving electrode layer 110 is provided with a plurality of driving lines 111 extending along a first axis (e.g., X axis). There is an insulating layer 15 under the driving electrode layer 110, and a sensing electrode layer 120 under the insulating layer 15. The sensing electrode layer 120 comprises a plurality of sensing lines 112 extending along a second axis (e.g., Y axis) and intersecting the driving lines 111 respectively. The driving lines 111 and the sensing lines 112 are made of transparent conductive materials, so that the hovering touch panel 11 can achieve the best visibility. There is an insulating material between the driving lines 111 and the sensing lines 112 at the intersections, and each of the intersections forms a respective intersected point 113, and each of the intersected points 113 forms a capacitance,

In this embodiment, the hovering touch panel 11 is an example of a common glass-film-film (GFF), and the driving lines 111 and the sensing lines 112 are respectively located on different layers of the hovering touch panel 11. But the actual implementation is not limited to this, and can be a combination of various glasses and films of the conventional touch panel.

In addition, in actual implementation, the driving lines 111 and the sensing lines 112 can also be arranged on the same layer, such as a common one-piece glass touch panel (One Glass Solution; OGS). There is insulation means between the driving lines and the sensing lines at the intersections.

Since the arrangement of the driving lines 111 and the sensing lines 112 is a familiar art in the field of touch technology, it will not be described in detail in this case.

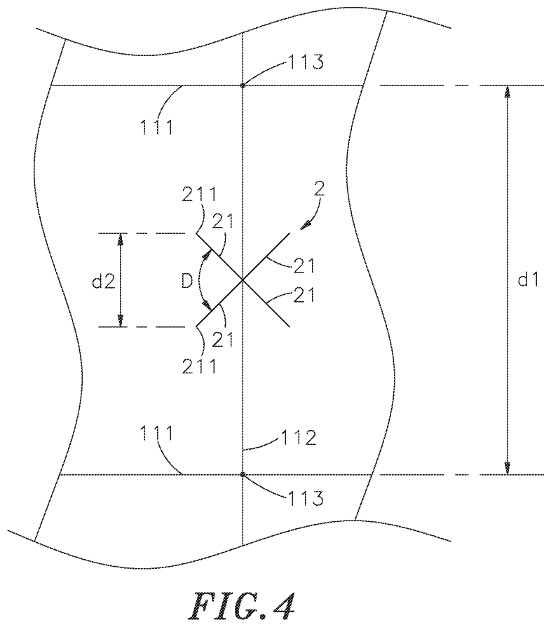

In particular, as shown in FIG. 3, the hovering touch panel 11 is also equipped with a plurality of hovering units 2 installed on the sensing lines 112. These hovering units 2 are electrically connected to the sensing lines 112. In this embodiment, the hovering units 2 and the sensing lines 112 are made of the same layer of transparent conductive material. As shown in FIG. 4, each hovering unit 2 is roughly in the shape of an X, with four linear hovering sections 21 connected to the same point on the sensing 112. However, in actual application, the number of hovering sections 21 is not limited to this, it can be an even number, such as two, four, six, etc., and it is not limited. The position where each hovering section 21 is connected to the sensing line 112 is roughly located at the center point between any two intersected points 113, and is arranged radially in the center, and the arrangement is symmetrical on the left and right sides and the upper and lower sides. In addition, the angle between any two adjacent hovering sections 21 is equal. For example, the hovering unit 2 in this embodiment has four hovering sections 21, and an angle D between any two adjacent hovering sections 21 is 90 degrees. If the hovering unit 2 has six hovering sections 21, the angle D between any two adjacent hovering sections 21 is 60 degrees.

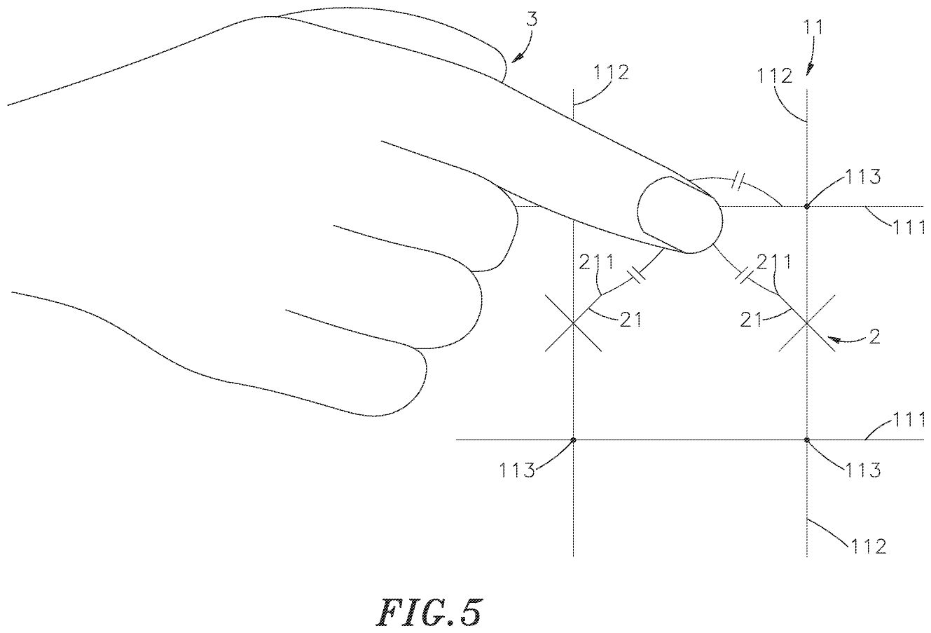

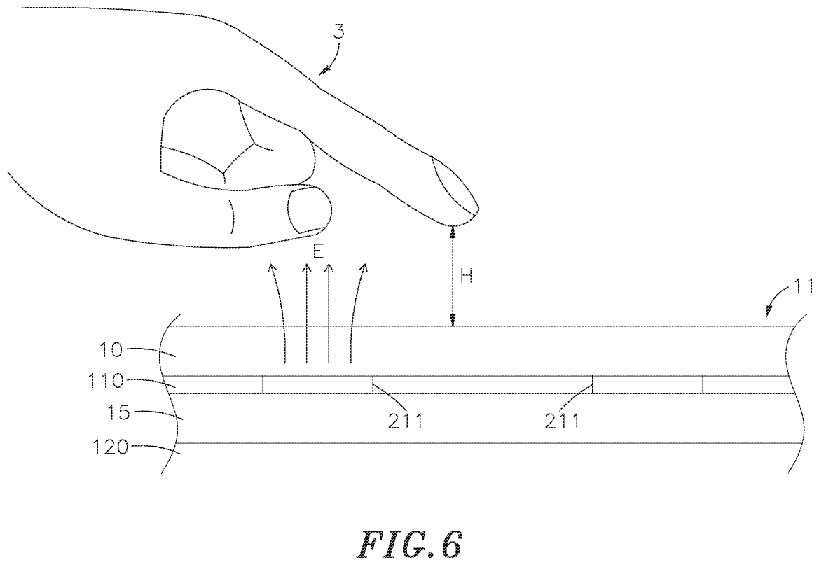

In actual operation, take FIG. 5 and FIG. 6 as an example. When the hovering unit 2 senses an object 3 (such as a finger or a stylus) close to the top of the hovering touch panel 11, since each hovering section 21 is extended by the sensing line 112, the charge density of a tip 211 of each hovering section 21 is much higher than other positions in the hovering section 21. Therefore, the tip 211 of each hovering section 21 generates a stronger electric field E when energized, so that the hovering touch panel 11 can sense the object 3 from distance H. Specifically, the distance d2 between the tips 211 of the two adjacent hovering sections 21 of the hovering unit 2 is between ⅕ and ⅘ of the distance d1 of the adjacent intersected points 113, and better results can be obtained.

Considering the size of the fingers of an average person, this embodiment sets the distance d1 between the adjacent intersected points 113 as 10 mm, and the distance d2 between the tips 211 of any two adjacent hovering sections 21 of the hovering unit 2 is between 2 mm and 8 mm. It obtains better results.

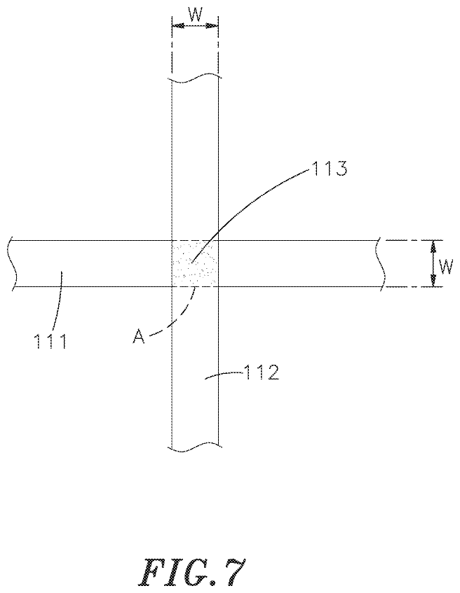

Furthermore, in actual application, as shown in FIG. 7, this embodiment limits the line width W of the straight driving lines 111 and the sensing lines 112 to less than 2 mm to minimize the intersected area A of the intersected points 113 between the driving lines 111 and the sensing lines 112, so that the capacitance formed by the intersected points 113 can be reduced as much as possible. By reducing the capacitance value of each intersected point 113, the sensing lines 112 can reduce the influence of the capacitance of the intersected points 113 on the signal when detecting the signal.

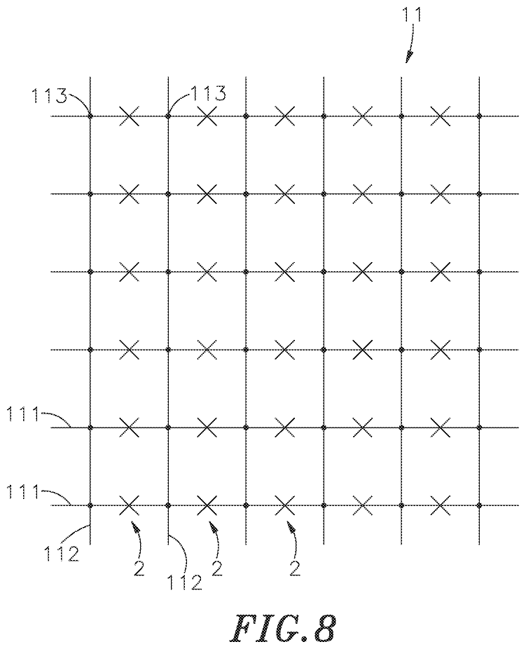

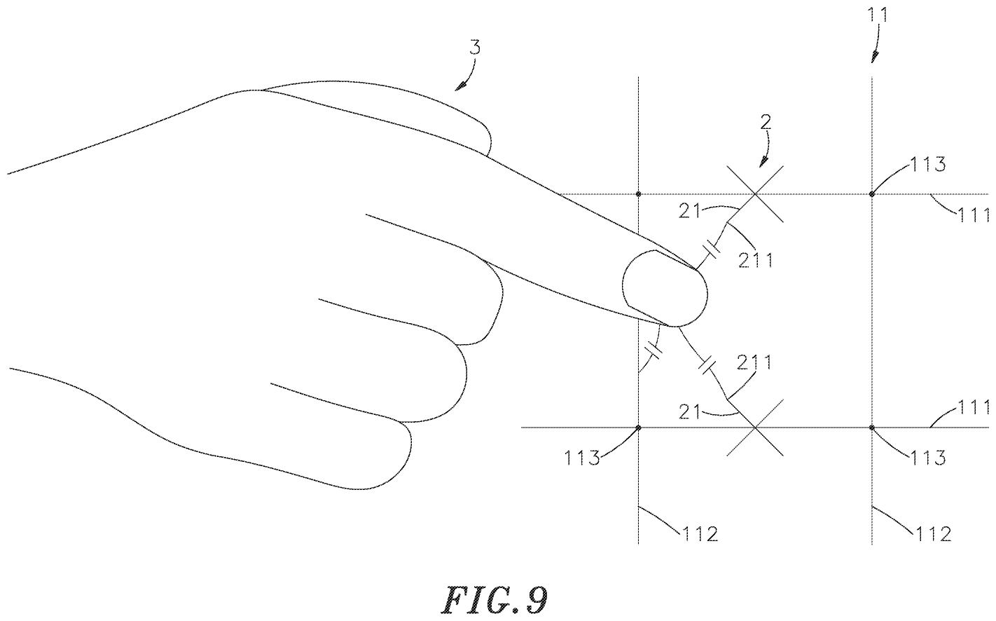

As shown in FIG. 8, these plural hovering units 2 can also be respectively arranged on the driving lines 111 of the adjacent intersected points 113. As shown in FIG. 9, the hovering units 2 and each driving line 111 are electrically connected. In this embodiment, the hovering units 2 and each driving line 111 are made of the same layer of transparent conductive material. Each hovering unit 2 is roughly in the shape of an X, with four linear hovering sections 21 connected to the same point on the driving line 111. In actual application, the number of hovering sections 21 is not limited by this, but can be an even number, such as two, four, six, etc., and it is riot limited by this. The position where each hovering section 21 is connected to the driving line 111 is roughly located at the center point between any two intersected points 113, and is arranged radially in the center, and the arrangement is symmetrical on the left and right sides and the upper and lower sides. Since each linear hovering section 21 is extended by the driving line 111, the charge density of the tip 211 of each hovering section 21 is much higher than other positions of each hovering section 1. As a result, the tip 211 of each hovering section 21 generates a stronger electric field when energized, so that the hovering touch panel 11 can sense the object 3 at a longer distance.

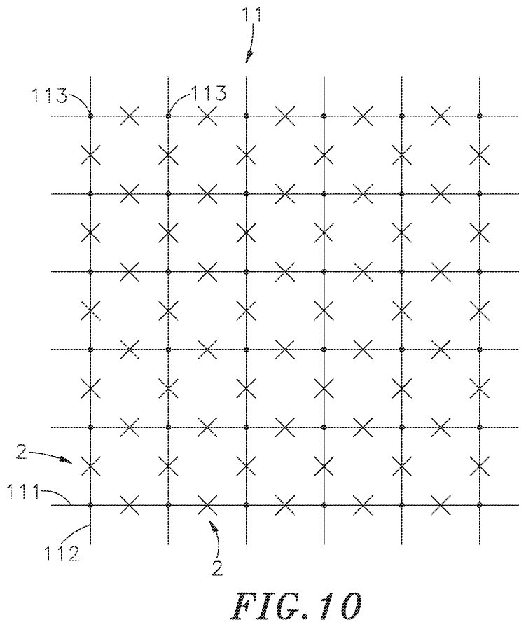

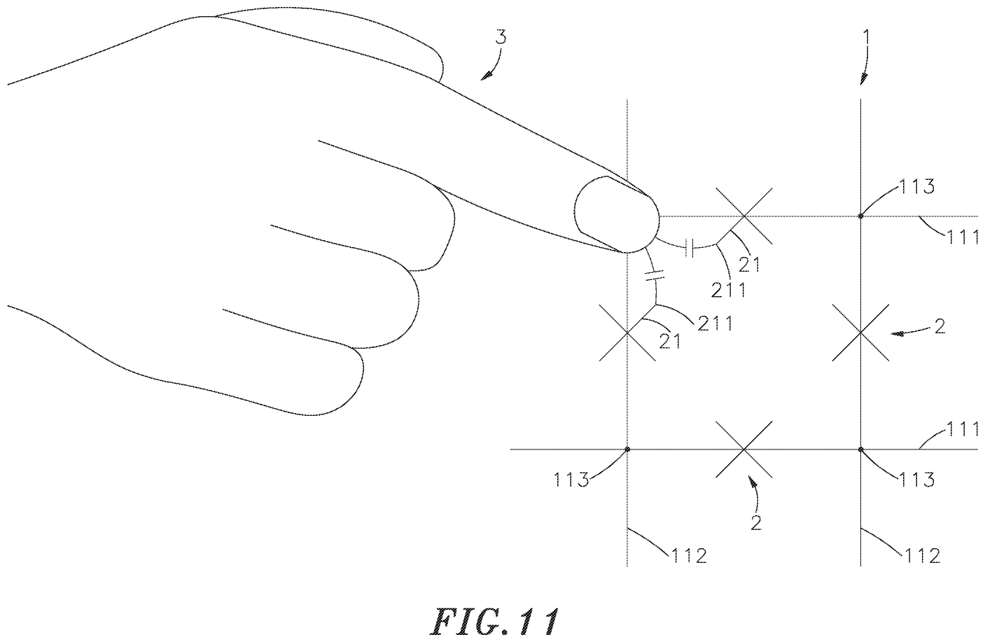

Similarly, as shown in FIGS. 10 and 11, these hovering units 2 can also be set on the driving lines 111 and the sensing lines 112 of the adjacent intersected points 113, respectively. Since each linear hovering section 21 is respectively extended by the driving line 111 and the sensing line 112, the charge density of the tip 211 of each hovering section 21 is much higher than other positions of each hovering section 21. As a result, the tip 211 of each hovering section 21 generates a stronger electric field when energized, so that the hovering touch panel 11 can sense the object 3 at a longer distance.

As shown in FIG. 1, the control circuit 12 is electrically connected to the driving lines 111 and the sensing lines 112 and drives the driving lines 111 by mutual capacitance, and the sensing lines 112 are used to detect electrical signals to obtain the coordinate position of the hovering object. Due to the mutual capacitance technology, multiple objects can be detected at the same time, achieving the purpose of detecting hovering objects at multiple points. Since the mutual capacitance technology is a known skill, it will not be described in detail in this embodiment. The processor 13 is electrically connected to the control circuit 12 for corresponding the coordinate position of the object 3 to the hovering touch panel 11, and executes the corresponding function of the application. The hovering touch device 1 further comprises the memory 14, which is electrically connected and can temporarily store the coordinate position data of the object 3 obtained by the processor 13.

The hovering touch panel 11 of this embodiment is equipped with the above-mentioned hovering units 2 and uses the tips 211. of the hovering sections 21 to increase the strength of the surrounding electric field, which can detect objects 3 with a greater distance from the hovering touch panel 11 during hovering detection. It can apply mutual capacitance technology to achieve the purpose of multi-point detection of hovering objects, which effectively overcomes the previous problem that self-capacitance hovering detection can only perform single-point detection, and must switch to mutual capacitance detection when touching the touch panel.

The above is only the preferred embodiment of the present invention, and the scope of the patent of the present invention is not limited thereby. Therefore, all simple modifications and equivalent structural changes made by using the description and schematic content of the present invention should be included in the patent scope of the present invention in the same way.

In summary, the above-mentioned hovering touch panel and hovering touch device of the present invention can indeed achieve their effects and purposes when used. Therefore, the present invention is an invention with excellent practicality. In order to meet the requirements of an invention patent application, I filed an application in accordance with the law. I hope that the examiner will grant this application as soon as possible to ensure the inventor's hard research and development. If there are any doubts, please don't hesitate to write instructions.

1. A hovering touch panel, comprising:
a plurality of driving lines extending along a first axis;
a plurality of sensing lines extending along a second axis and intersecting said driving lines respectively, intersections of said driving lines and said sensing lines each forming a respective intersected point; and
a plurality of hovering units respectively set on said driving lines or said sensing lines between adjacent said intersected points, each said hovering unit comprising an even number of linear hovering sections connected to a same point of each said driving line or said sensing line,
wherein each said hovering section terminates in a tip, and a distance between the tips of each two adjacent said hovering sections of each said hovering unit is between ⅕ and ⅘ of a distance between each two adjacent said intersected points, and
wherein said driving lines and said sensing lines are all straight lines, and a line width of said driving lines and said sensing lines is less than 2 mm.

2. The hovering touch panel as claimed in claim 1, wherein a position where each said hovering section is connected to each said driving line or said sensing line is roughly located at a center point between any two said intersected points.

3. The hovering touch panel as claimed in claim 1, wherein an angle between any two adjacent said hovering sections is equal.

4. The hovering touch panel as claimed in claim 1, wherein each said hovering section presents a central radial arrangement, and the arrangement is symmetrically arranged on left and right sides and top and bottom sides.

5. (canceled)

6. (canceled)

7. The hovering touch panel as claimed in claim 1, wherein said hovering units, said driving lines, and said sensing lines are made of transparent conductive materials.

8. A hovering touch device, comprising:
a hovering touch panel, comprising a plurality of driving lines extending along a first axis, a plurality of sensing lines extending along a second axis and intersecting said driving lines respectively, intersections of said driving lines and said sensing lines each forming a respective intersected point, and a plurality of hovering units respectively set on said driving lines or said sensing lines between adjacent said intersected points, each said hovering unit comprising an even number of linear hovering sections connected to a same point of each said driving line or said sensing line; and
a control circuit electrically connecting said driving lines and said sensing lines, said control circuit being adapted for driving said driving lines and detecting electrical signals from said sensing lines to obtain a coordinate position of at least one object in a floating state,
wherein each said hovering section terminates in a tip, and a distance between the tips of each two adjacent said hovering sections of each said hovering unit is between ⅕ and ⅘ of a distance between each two adjacent said intersected points, and
wherein said driving lines and said sensing lines are all straight lines, and a line width of said driving lines and said sensing lines is less than 2 mm.

9. The hovering touch device as claimed in claim 8, wherein a position where each said hovering section is connected to each said driving line or said sensing line is roughly located at a center point between any two said intersected points.

10. The hovering touch device as claimed in claim 8, wherein each said hovering section presents a central radial arrangement, and the arrangement is symmetrically arranged on left and right sides and top and bottom sides.

11. The hovering touch device as claimed in claim 8, wherein an angle between any two adjacent said hovering sections is equal.

12. (canceled)

13. (canceled)

14. The hovering touch device as claimed in claim 8, wherein said hovering units, said driving lines, and said sensing lines are made of transparent conductive materials.

15. The hovering touch device as claimed in claim 8, further comprising:
a processor electrically connected to said control circuit and used to correspond the coordinate position of said object to said hovering touch panel and execute a corresponding function of an application; and
a memory electrically connected to said processor and used to temporarily store coordinate position data of said object obtained by said processor.
